(19) United States
(12) Patent Application Publication
(10) Pub. No.: US 2005/0154737 A1
(43) Pub. Date: Jul. 14, 2005

(54) Clipping service for licensable works of authorship

(76) Inventor: Michael O'Donnell, Issaquah, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/027,217

(22) Filed: Dec. 29, 2004

Related U.S. Application Data
(60) Provisional application No. 60/533,286, filed on Dec. 29, 2003.

(51) Int. Cl. G06F 7/00

(52) U.S. Cl. 707/10

(57) ABSTRACT

A method for implementing a clipping service for works of authorship through which users can receive in electronic form abstracts of the works of authorship based upon the users' specific, pre-defined criteria where each abstract contains links (an anchor, a hot spot) to the full work and where each abstract contains one or more unique licensing tags, represented by a visible icon or text link (an anchor, a hot spot), that allows each work of authorship to be licensed according to the copyright rules and permissions established by each author and/or publisher of said works. The abstracts may also include links to information about the author and/or publisher and publication date.

### SUMMARY OF THE INVENTION

In one aspect, the invention is a method for implementing a clipping service for works of authorship through which users can receive in electronic form abstracts of the works of authorship based upon the users' specific, pre-defined criteria where each abstract contains links (an anchor, a hot spot) to the full work and where each abstract contains one or more unique licensing tags, represented by a visible icon or text link (an anchor, a hot spot), that allows each work of authorship to be licensed according to the copyright rules and permissions established by each author and/or publisher of said works. The abstracts may also include links to information about the author and/or publisher and publication date.

In another aspect, the method may include a feature whereby one of the tags, represented by an icon or text link (an anchor, a hot spot), allows the reader to subscribe to the publication that published the work of authorship. The subscription may allow the reader to receive notification of when the work has been modified or updated.

In another aspect, the method may include a feature whereby each abstract may contain an advertisement, promotion, or other offer that is related to the query topic of the user and/or the predefined profile of the user making the query.

### BRIEF DESCRIPTION OF THE DRAWINGS

FIG. 1 shows an abstract with the 5 types of links.

### DETAILED DESCRIPTION

The detailed description and the drawings illustrate specific exemplary embodiments by which the invention may be practiced. Other embodiments may be utilized, and other changes may be made, without departing from the spirit or scope of the present invention. The following detailed description is therefore not to be taken in a limiting sense, and the scope of the present invention is defined by the stated claims.

Unlike a search engine or news service, the invented method only provides abstracts of works that contain the unique licensing tags, which guarantees that the works are licensable from the author and/or publisher (whomever has the rights to grant copyright permissions). The methods for incorporating tags into published works of authorship and providing access to licensing web pages and offering licenses to users who access those pages is described in U.S. patent application Ser. No. 09/245,798 which is hereby incorporated by reference.

Unlike a search engine, the invented method delivers highly relevant results by exploiting the unique tags within a work to separate the wheat from the chaff before indexing it. In a normal search application or web clipping service, a user typically gets hits on advertisements, navigation elements, or other superfluous content, because it's not clear which part of the article is body content and which isn't. A search engine and traditional web clipping service cannot distinguish the work of authorship from other content that may be published alongside of the work. The method can distinguish a work from other content by “interpreting” the tags.

The works of authorship that are available through the service may be news stories, white papers, case studies, reports, books, music, video, pictures or graphics, and any other form that works of authorship may take.

The abstracts of licensable works of authorship are delivered (pushed) to the user so that the user does not have to search (pull) for them. The abstracts are created in real-time using the unique tags in combination with the keywords created by the user, making the abstracts of the works highly relevant to the user. The abstracts are also more timely than other works available to users, since they are created and sent to users (subscribers) within 24 hours of the work being published.

The Search Criteria

Like a search engine, users can define keywords that might match with the types of works they are interested in receiving abstracts about. Like a search engine, users can confine their keywords to classes or categories of works, such as “Health Care,” “Business,” and “Entertainment.” Unlike search engines, users of the invented methods can define their search criteria to include abstracts from only specific publications, web sites, or databases, all of which publish works that may be readily licensed by virtue of having embedded the unique tags.

The Links (Full Work, Publication, Licensing Rights, Subscription, Advertisement)

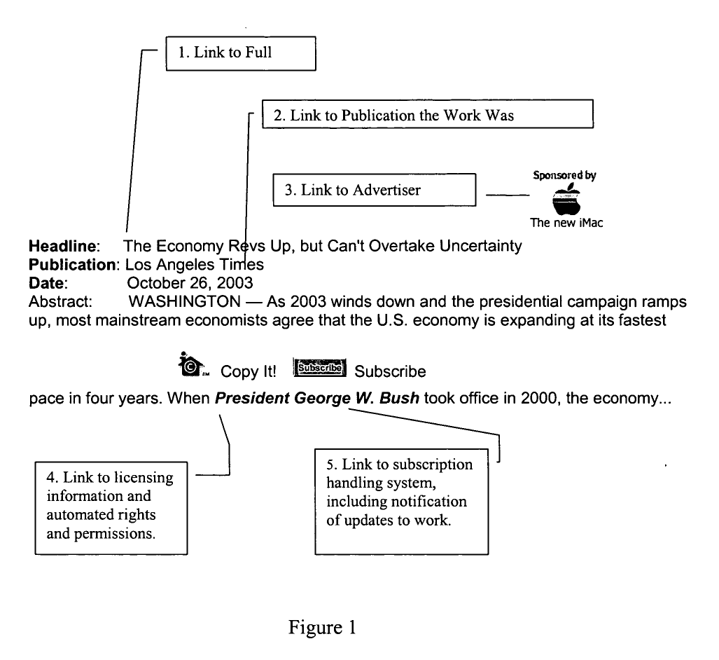

Users may receive in electronic form an unlimited number of abstracts, of an unlimited number of topics, from an unlimited number of works of authorship. For example, a user may receive in any one day 25 abstracts on the topic “President George W. Bush,” from thousands of works that include mention of George W Bush. The number of abstracts will be determined by how broad or narrow the topic, as well as the number of available works that have embedded the tags from which the abstracts are created. Each abstract may contain as many as five (5) distinct links, each represented by an icon, image, or text, as shown in FIG. 1. First, link type 1 may provide access to the full work. Second, link type 2 may provide access to the publication the work was published in. Third, link type 3 may provide access to one or more advertisers. Fourth, link type 4 may provide access to a licensing web page where rights to reproduce or distribute the work may be acquired. Fifth, link type 5 may provide access to a web page where a subscription to the publication or to an update service may be purchased.

Each click by a user on a link is recorded and reported to the owner and/or publisher of the work. This feature provides authors and publishers with information about which of their works are being read and downloaded by users and, in some cases, information about how their works are being used.

If the reader sees a type 4 link, the reader knows that the work is licensable. The name of the publisher may indicate to the reader that the reader has already paid for a license to reproduce articles from that publisher. Such information may make it easier for a reader to do his or her job so the reader will prefer to subscribe to a clipping service that provides such information at a glace or that allows filter selection based on whether any of the link types is present or with particular link identifying information.

Although the present invention has been described in detail with reference to certain preferred embodiments, other embodiments are possible. Therefore, the spirit or scope of the appended claims should not be limited to the description of the embodiments contained herein. It is intended that the invention resides in the claims hereinafter appended.

1. A method on a server in a computer network for an abstract publishing service to select and transmit to a subscriber an abstract of a work where the abstracted work may be licensed via the network, comprising:
a. receiving from a client computer a set of filtering specifications for selecting abstracts of published works of authorship including a specification that the work must be licensable by computer communication on the network;
b. receiving a record of information about a published work of authorship which record includes a document identification tag indicating that the work is licensable by computer communication on the network; and
c. in response, providing to the client computer an abstract of the work which abstract includes a link to a licensing web page where use of the work may be licensed.

2. The method of claim 1 where the abstract further includes a link to the published work.

3. The method of claim 1 where the abstract further includes a link to a web site of a publication the work was published in.

4. A method on a server in a computer network for an abstract publishing service to transmit to a subscriber an abstract of a work where the abstracted work may be subscribed to via the network, comprising:
a. receiving from a client computer a set of filtering specifications for selecting abstracts of published works of authorship;
b. receiving a record of information about a published work of authorship which record includes information satisfying the filtering specifications; and
c. in response, providing to the client computer an abstract of the work which abstract includes a link to a subscription web page where a subscription to a publication that published the work may be purchased.

5. The method of claim 4 where the abstract further includes a link to the published work.

6. The method of claim 4 where the abstract further includes a link to a web site of the publication the work was published in.

7. A method on a server in a computer network for an abstract publishing service to transmit to a subscriber an abstract for a work where a publication the abstracted work was published in may be accessed via the network, comprising:
a. receiving from a client computer a set of filtering specifications for selecting abstracts of published works of authorship;
b. receiving a record of information about a published work of authorship which record includes information satisfying the filtering specifications; and
c. in response, providing to the client computer an abstract of the work which abstract includes a link to a web page where a publication in which the work was published may be viewed.

8. The method of claim 4 where the abstract further includes a link to the published work.

9. The method of claim 5 where the abstract further includes a link to a web site of an advertising sponsor of the abstract.
